(19) United States
(12) Patent Application Publication
(10) Pub. No.: US 2007/0246939 A1
(43) Pub. Date: Oct. 25, 2007

(54) Perpetual motion machine

(76) Inventor: Paul Wayne McDonald, Hernando, MS (US)

Correspondence Address: Paul McDonald, 7243 Love RD, Hernando, MS, 38632, US

(21) Appl. No.: 11/281,660

(22) Filed: Apr. 11, 2006

(51) Int. Cl. H02K 7/18

(52) U.S. Cl. 290/1 R

(57) ABSTRACT

It is a motor which runs on Prepetual Motion.IT only requires synthetic oil to lubricate metal parts to prevent friction breakdown no Electricity or Fuel required I PAUL WAYNE MCDONALD claim to be the only one who has ever Invented a Perpetual Motor to the best of my knowledge

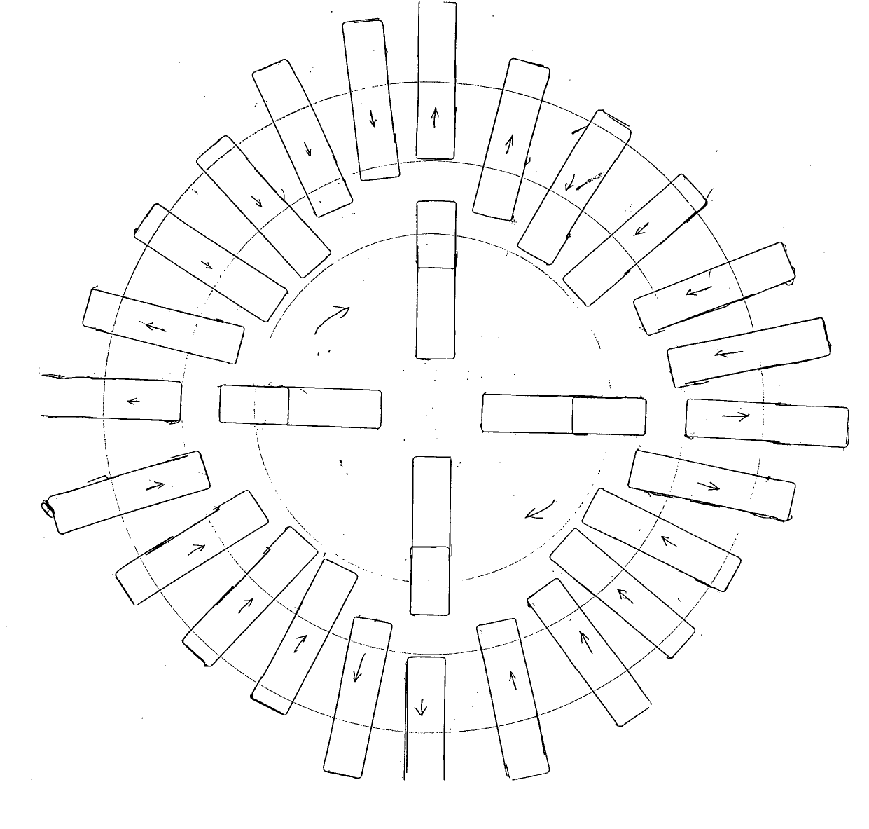

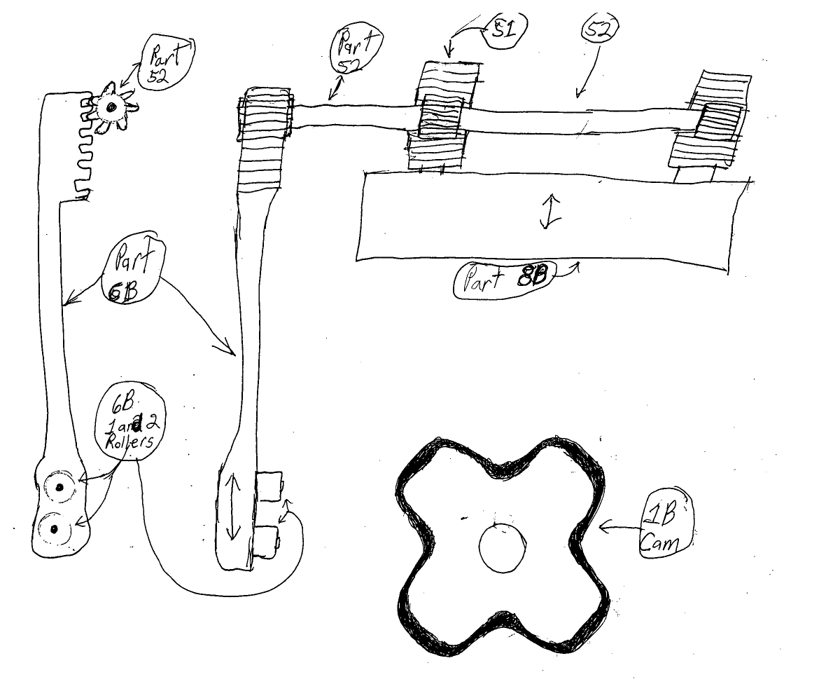

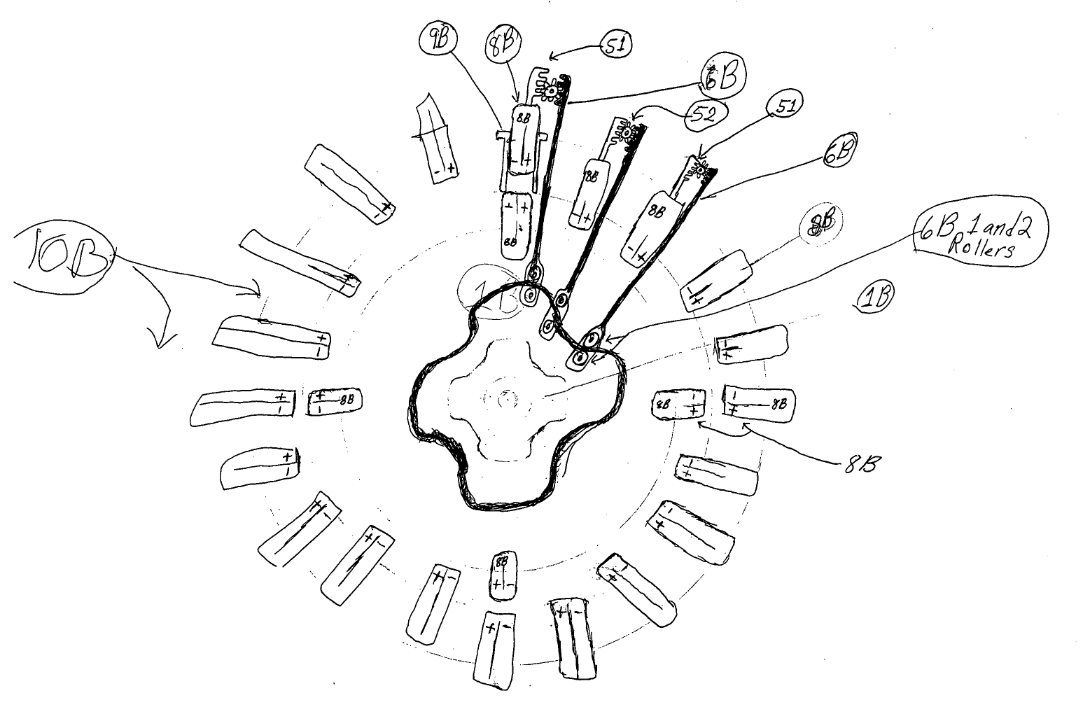

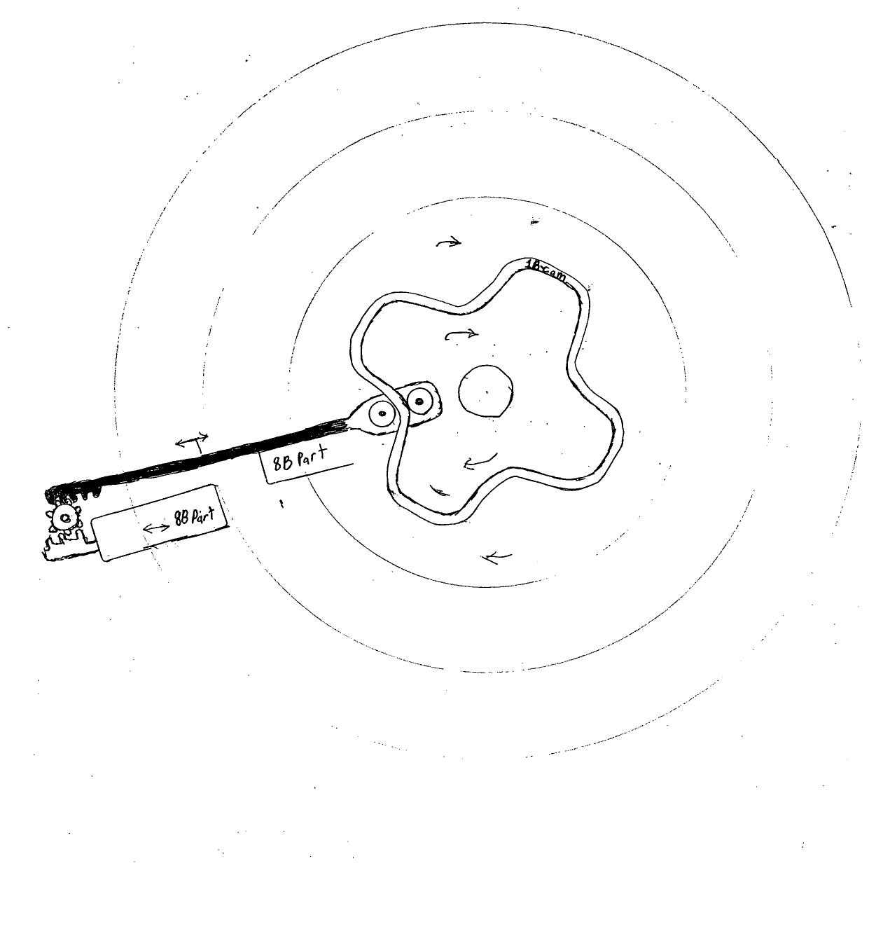

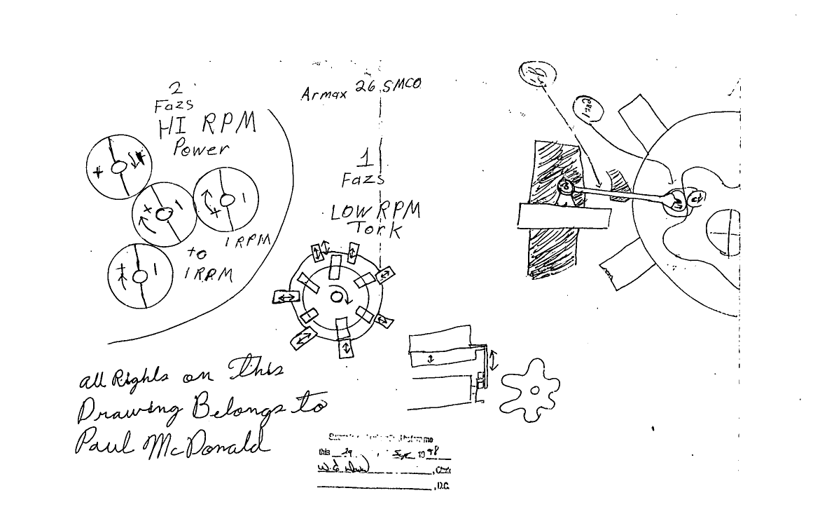

B6 IS A Lifter shaft with gears at one end toward the outside of the circle and 2 rollers towards the center of the circle that ride on a clover leaf shaped cam B7 that resembles bunt cake pan B8 main shaft housing for B 20 magnets that bolt in it the B 21 magnets are timed by the B 6 and B 7 the B7 is on the front end B8 the B21 will move away from B20 just so B21 can get by then it drop back down to magnet pulls the next B20 over and over B6 rides on b7 cam B6 goes up down B82 are timing gear set B10 is the outer motor block that holds the parts in place.

B8 has a arrow pointing in the direction it is turning clockwise B20 are bolted to B8 and the B21 move up down just so the B20 can get by just missing each other

B7 is a bunt shaped cam there is 2 cams the B6 has 2 rollers that ride on inner and outer rim of B7 b6 has gears on one end that are for timing

B8 the front end and how it is shaped with notches on the outer edges so B20 can be bolted in the notches in the center of B8 is 4 more notches so a main shaft that has 4 more notches will fit in it and B7 be time with B8

This is a side view of the motor the white dots are bolts that hold the magnets in the main shaft B8

This is the outer magnet B21 it has a gear set that bolts on it, the white spots are the bolts holes and B21-B is red and it is the gears for timing the B21 on the B8 main shaft

B 82 Is a degree gears for the timing on each one of the B21 magnets

### COLOR CODE FOR METALS ON DRAWINGS

1-The green parts 7075-T6 Aluminum
2-The yellow parts 9310 Steel Alloy
3-The white dots on page 5 are 8740 Steel Alloy
4-The Blue parts ARMAX 26 SMCO Magnet Alloy
5-The red parts 4130 Chromemoly And on the ends the gears are 9310 Steel Alloy

I claim:

1. I am the only one that knows how to make this Perpetual Motion Motor and it work! I started on it when I was 8 years old, My Father told me that we are the Caretakers of the Earth, So I Established My Goals to make this Perpetual Motion Motor at age of 8 years old and this is my claim! The Magnets are put in a timed working order that they will push and pull in away that will be in Perpetual Motion I Have Worked on this all Alone no one helped Me with this I did it all by myself in 31 Years of work I Paul Wanes McDonald the End of this claim.
